(19) United States
(12) Patent Application Publication
(10) Pub. No.: US 2020/0256282 A1
(43) Pub. Date: Aug. 13, 2020

(54) TURBOJET COMPRISING A THRUST REVERSER DRIVE MECHANISM

(71) Applicant: Airbus Operations SAS, Toulouse (FR)

(72) Inventors: Fabien MENOU, SAINT JEAN (FR); Laurent CAZEAUX, TOURNEFEUILLE (FR); Benoit ORTEU, TOULOUSE (FR)

(21) Appl. No.: 16/736,474

(22) Filed: Jan. 7, 2020

(30) Foreign Application Priority Data
Feb. 7, 2019 (FR) 1901222

(51) Int. Cl. F02K 1/70; F02K 1/76

(52) U.S. Cl. CPC F02K 1/70; B64D 29/06; F02K 1/763

(57) ABSTRACT

A turbojet comprising a nacelle with a fixed cowl, a fan duct and a thrust reverser comprising a cowl movable between a stowed and a deployed position where the movable cowl is remote from the fixed cowl, at least one blocking flap movable between the closed position and a fixed position where the flap at least partially blocks the fan duct, and also a drive mechanism for moving the movable cowl and the blocking flap. The drive mechanism comprises a roller slide comprising a rail and a roller rotatable in the rail, a connecting rod with a first end movable on the roller and a second end movable on the blocking flap. The rail comprises a bearing surface extending parallel to a turbojet longitudinal axis to support the connecting rod during movement of the movable cowl from the stowed position to an intermediate position between the stowed and deployed positions.

### CROSS-REFERENCES TO RELATED APPLICATIONS

This application claims the benefit of the French patent application No. 1901222 filed on Feb. 7, 2019, the entire disclosures of which are incorporated herein by way of reference.

### FIELD OF THE INVENTION

The present invention relates to a bypass turbojet that comprises a thrust reverser and a mechanism for driving the reverser.

### BACKGROUND OF THE INVENTION

A bypass turbojet comprises a nacelle surrounding an engine with a fan for defining a fan duct that allows the passage of a flow of air expelled as a result of the rotation of the fan.

The turbojet comprises a thrust reverser located at the rear of the nacelle and which comprises a movable cowl, a plurality of blocking flaps and a mechanism for driving the thrust reverser. A movable cowl is movable in translation through the effect of the drive mechanism between a stowed position, in which it is in contact with a fixed cowl of the nacelle such as to ensure aerodynamic continuity of the nacelle, and a deployed position in which the movable cowl is remote from the fixed cowl towards the rear of the nacelle such as to enlarge an opening between the fan duct and the exterior of the nacelle.

Each blocking flap, positioned at the opening, has a movement mechanically linked to the translation of the movable cowl. Thus, a blocking flap is movable between a closed position, in which it does not block the fan duct so as not to impede the flow of air when the movable cowl is in the stowed position, and an open position, in which it is positioned across the fan duct in order to direct part of the flow of air through the opening towards the exterior of the nacelle when the movable cowl is in the deployed position.

With a view to optimizing the performance of the engine upon activation of the thrust reverser upon landing, it is desirable to identify deployment mechanisms that make it possible to delay the opening of the blocking flap relative to the movement of the movable cowl towards its deployed position.

Patent application EP2776699 discloses a deployment mechanism that uses a lever principle for the opening of the blocking flap with a view to ensuring a delay in the opening of the flap relative to the movement of the movable cowl towards its deployed position.

### SUMMARY OF THE INVENTION

An object of the present invention is to propose a different type of mechanism for delayed opening of the flap. To that end, the invention relates to a turbojet comprising an engine, a nacelle with a longitudinal axis and a fan duct defined between the nacelle and the engine, the nacelle having a chassis, a fixed cowl and a thrust reverser mounted on the chassis, the reverser comprising a movable cowl mounted to move on the chassis in translation in a translational direction between a stowed position, in which the cowl is in contact with the fixed cowl, and a deployed position in which the movable cowl is remote from the fixed cowl, at least one blocking flap that is moveable in rotation about an axis perpendicular to the longitudinal axis on the movable cowl between a closed position, in which the flap releases the fan duct, and an open position in which the flap blocks the fan duct at least in part, and also a drive mechanism for moving the movable cowl and the at least one blocking flap, the drive mechanism comprising:
a roller slide integral with the chassis and comprising a rail extending in the translational direction and a roller that can move in rotation in the rail over the total length of the rail defined between a first end of the rail attained when the blocking flap is in the closed position and the movable cowl is in the stowed position and a second end of the rail attained when the blocking flap is in the open position and the movable cowl is in the deployed position,
a connecting rod, of which a first end is mounted to move in rotation on the roller about an axis of rotation perpendicular to the longitudinal axis and of which a second end is mounted to move on the at least one blocking flap about an axis of rotation perpendicular to the longitudinal axis,

the rail comprising a bearing surface extending in the translational direction and parallel to the longitudinal axis such as to support the connecting rod during the movement of the movable cowl from the stowed position to an intermediate position of the movable cowl, the intermediate position being between the stowed position and the deployed position of the movable cowl.

### BRIEF DESCRIPTION OF THE DRAWINGS

The above-mentioned features of the invention, and also other features, will become more clearly apparent upon reading the following description of an exemplary embodiment, the description being given with reference to the appended drawings, in which:

FIG. 1 is a side view of an aircraft comprising a turbojet according to the invention;

FIG. 2 is a sectional view of the turbojet according to the invention, which comprises a thrust reverser;

FIG. 3 is a sectional view of a thrust reverser according to a first embodiment of the invention, in an activated state;

FIG. 4 is a view similar to that of FIG. 3 of the thrust reverser according to a first embodiment of the invention, in an intermediate state;

FIG. 5 is a view similar to that of FIG. 3 of the thrust reverser according to a first embodiment of the invention, in a deactivated state;

FIG. 6 is a sectional view of a rail of a mechanism for driving the thrust reverser according to one embodiment of the invention;

FIG. 7 is a sectional view of a thrust reverser according to a second embodiment of the invention, in an activated state;

FIG. 8 is a view similar to that of FIG. 7 of the thrust reverser according to a second embodiment of the invention, in an intermediate state;

FIG. 9 is a view similar to that of FIG. 8 of the thrust reverser according to a second embodiment of the invention, in a deactivated state.

### DETAILED DESCRIPTION OF THE PREFERRED EMBODIMENTS

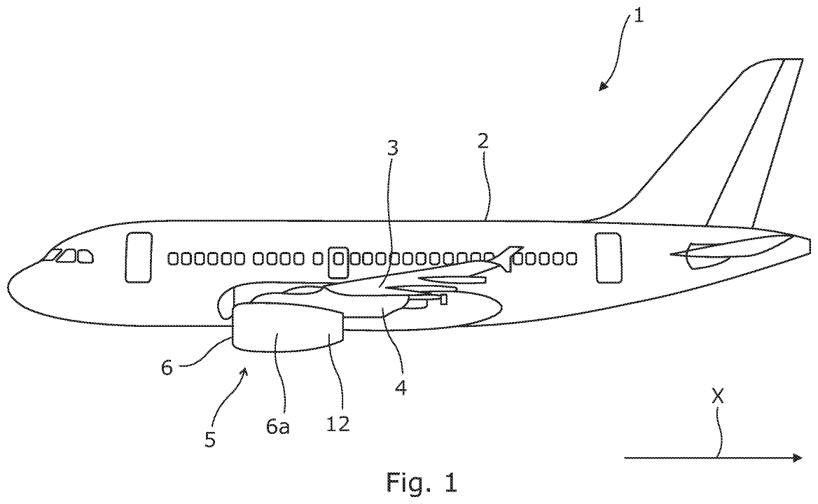

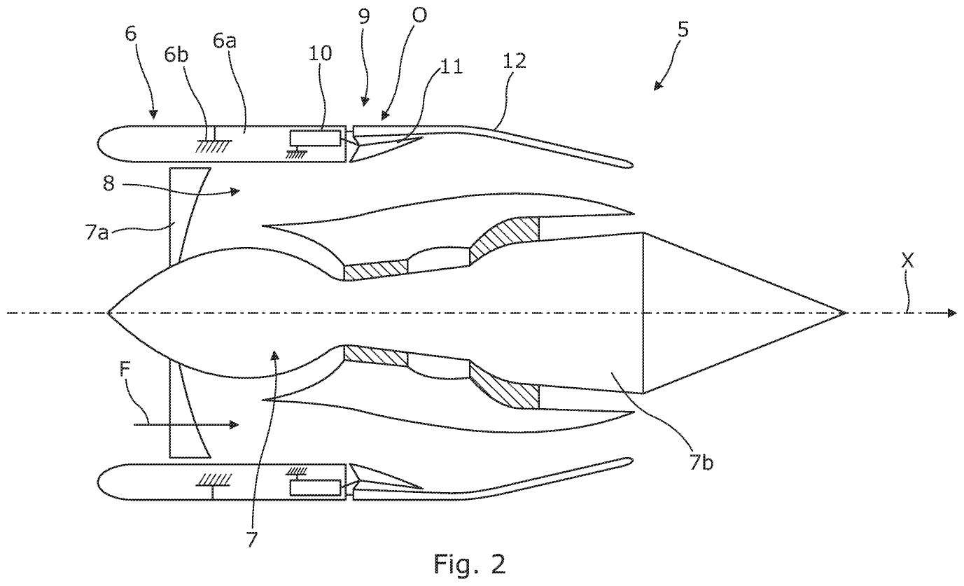

With reference to FIGS. 1 and 2, an aircraft 1 comprises a fuselage 2, on each side of which is arranged a wing 3, under which is secured, via a pylon 4 (not shown in FIG. 2), at least one bypass turbojet 5 according to the invention. The turbojet 5 comprises a nacelle 6 surrounding an engine 7 (not shown in FIG. 1), which comprises, from front to rear of the nacelle 6 on the longitudinal axis X of the nacelle, a fan 7a then an engine body 7b configured such as, when in operation, to drive the fan 7a.

The turbojet 5 comprises, in the extension of the fans 7a, an air duct 8, called the fan duct, defined between the nacelle 6 and the engine 7. When the engine 7 is in operation, a flow of air F expelled by the fan 7a circulates in the fan duct 8 in order to be expelled to the rear of the turbojet 5.

The nacelle 6 further comprises a chassis 6b (not shown in FIG. 1, but shown by means of the symbol of a fixed structure in FIGS. 2 to 9) formed by beams or other structural elements and, from front to rear in the direction of forward movement of the aircraft 1, a fixed cowl 6a mounted immovably on the chassis 6b then at least one thrust reverser 9 that comprises parts that can move through the action of a drive mechanism 10.

According to the invention, the drive mechanism 10 is configured such as to co-ordinate the switch from the closed position to the open position of the blocking flap 11 with the switch from the stowed position to the deployed position of the movable cowl 12, but also such as to delay the switch from the closed position to the open position of the blocking flap 11 as compared with the switch from the stowed position to the deployed position of the movable cowl 12.

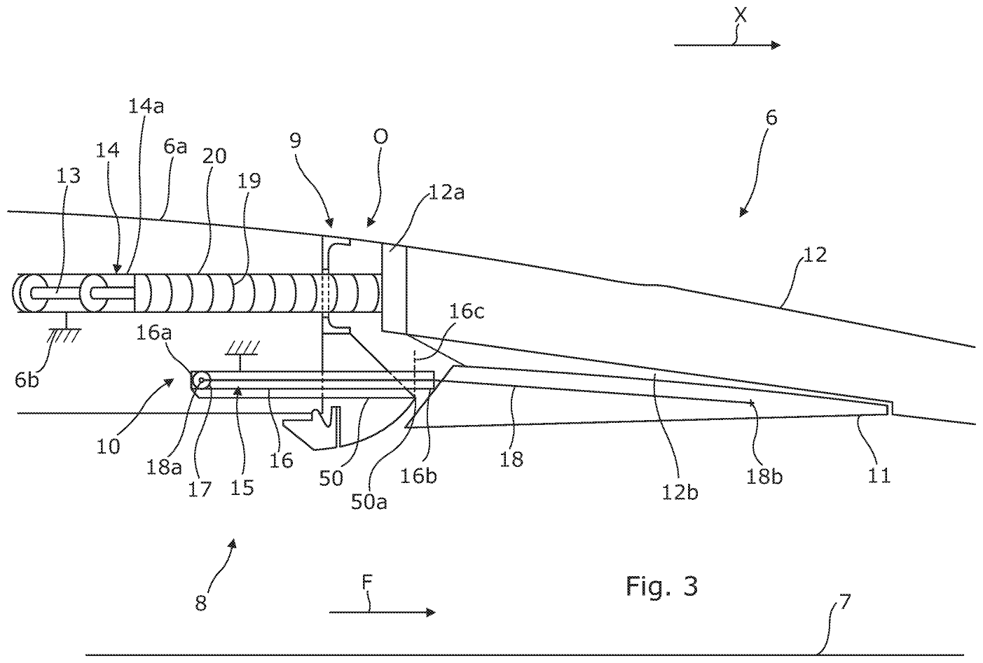

According to one embodiment of the invention, illustrated in FIGS. 3 to 5, the movable parts of the thrust reverser 9 comprise, in particular, at least one blocking flap 11, one movable cowl 12, and cascades.

Each of the fixed cowl 6a and the movable cowl 12 has an exterior surface that constitutes the exterior shell of the nacelle 6 and an interior surface that constitutes an exterior wall of the fan duct 8. The nacelle 6 further has, for each blocking flap 11, a through-opening O via which the fan duct 8 and the exterior of the nacelle are able to communicate.

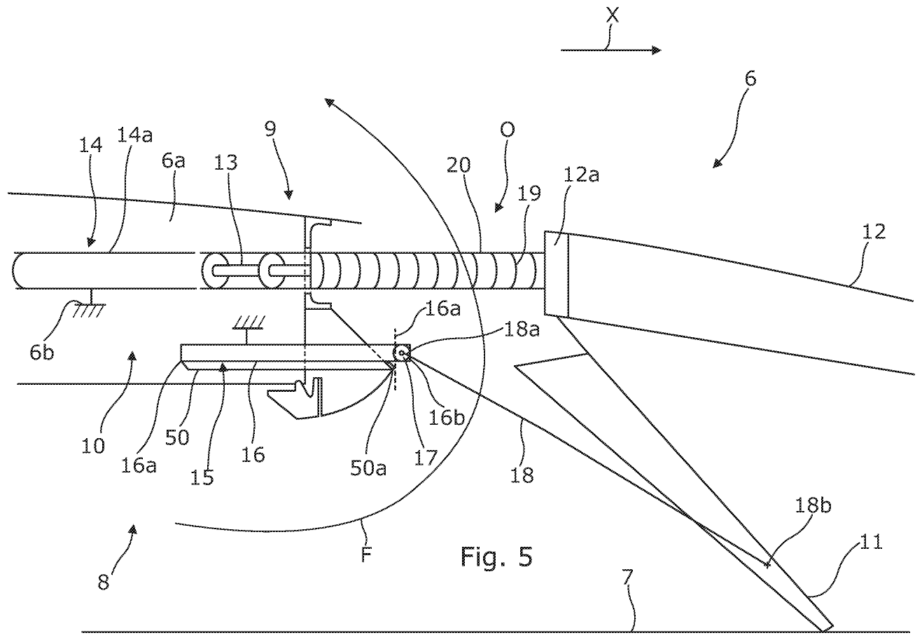

The movable cowl 12 is mounted to move in translation on the chassis 6b in a translational direction globally parallel to the longitudinal axis X between a stowed position (FIG. 3), in which it is in contact with the fixed cowl 6a in order to close the opening O, and a deployed position (FIG. 5), in which it is remote from the fixed cowl 6a so as to enlarge the opening O. The translation of the movable cowl 12 is achieved by any appropriate means (not shown) such as, for example, actuators of the electric or hydraulic ram type, for pushing or pulling their movable cowl 12 in the translational direction and slides arranged on the lateral edges of the movable cowl, where each slide is formed by a fitting affixed to the movable cowl and sliding in a groove arranged on the fixed structure.

Each blocking flap 11 is mounted to move on a front frame 12a of the movable cowl 12 about an axis of rotation substantially perpendicular to the longitudinal axis X, between a closed position (FIG. 3) and a deployed position (FIG. 5), for which thrust reversal has maximum efficiency.

In the closed position, the blocking flap 11 is positioned outside the fan duct 8 and, more particularly, in the embodiment shown, is housed in a recess 12b formed at the interior surface of the movable cowl 12. In the open position, the blocking flap 11 lies across the fan duct 8 and deflects at least some of the flow of air F towards the exterior and towards the front of the nacelle, through the opening O.

The cascades 19 are arranged on a housing 20 (“cascade box”) that can move relative to the fixed structure and which is integral with the movable cowl 12. In the deployed position of the movable cowl 12, the cascades 19 are positioned across the opening O such as, forwards and towards the exterior of the nacelle, to orient the flow of air F blocked by the blocking flap 11, while in the stowed position of the movable cowl 12 the cascades are arranged below the fixed cowl 6a.

The drive mechanism 10 is configured such as to co-ordinate the switch from the closed position to the open position of the blocking flap 11 with the switch from the stowed position to the deployed position of the movable cowl 12.

According to the invention, the drive mechanism 10 comprises:
a slide bar 13 secured to the housing 20 of the cascades;
means 14 for guiding the slide bar that are integral with the chassis 6b and designed to guide the slide bar 13 in translation parallel to the translational direction relative to the chassis 6b between two stop positions, one corresponding to the stowed position of the movable cowl 12 and the other corresponding to the deployed position of the movable cowl 12. The guide means 14 have, for example, the form of a groove 14a integral with the chassis and along which the slide bar 13 slides. The ends of the groove 14a are closed off in order to limit the movement of the slide bar 13 between the ends and thus to determine the position of the two stop positions;
a roller slide 15 integral with the chassis 6b, the roller slide 15 comprising a rail 16 extending in the translational direction and a roller 17 that can move in rotation in the rail 16 between a first end 16a of the rail 16 attained when the blocking flap 11 is in the closed position and the movable cowl 12 is in the stowed position and a second end 16b of the rail attained when the blocking flap 11 is in the open position and the movable cowl 12 is in the deployed position,
a connecting rod 18, of which a first end 18a, preferably the front end as shown in FIGS. 3 to 5, is mounted to move in on the center of the roller 17 about an axis of rotation perpendicular to the longitudinal axis X and of which a second end 18b is mounted to move on the blocking flap 11 about an axis of rotation perpendicular to the longitudinal axis X.

The rail 16 comprises a bearing surface 50 extending in the translational direction and globally parallel to the longitudinal axis X such as to support the connecting rod 18 during the movement of the movable cowl 12 from the stowed position to an intermediate position of the movable cowl 12, the intermediate position being between the stowed position and the deployed position of the movable cowl 12.

The bearing surface 50 extends from the first end 16a of the rail 16 as far as a pivot position 16c attained when the movable cowl 12 is in the intermediate position. The connecting rod 18 supported by the bearing surface 50 is restricted in translation in the translational direction in such a manner that the flap is unable to open.

On the other hand, in step with the connecting rod 18 no longer being supported by the bearing surface 50, i.e. beyond the pivot position, the connecting rod 18 is free to pivot about the center of the roller 17 in such a manner that the flap is able to move towards its open position.

Preferably, at the pivot position 16c, the bearing surface 50 has a ramp 50a extending in the translational direction and inclined relative to the longitudinal axis X so as to facilitate progressive insertion of the connecting rod in the rail 16 or, conversely, to facilitate the progressive exit of the connecting rod 18 outside of the rail 16. The plane of the ramp 50a is inclined, for example, at an angle of the order of 5 to 30° relative to the longitudinal axis X.

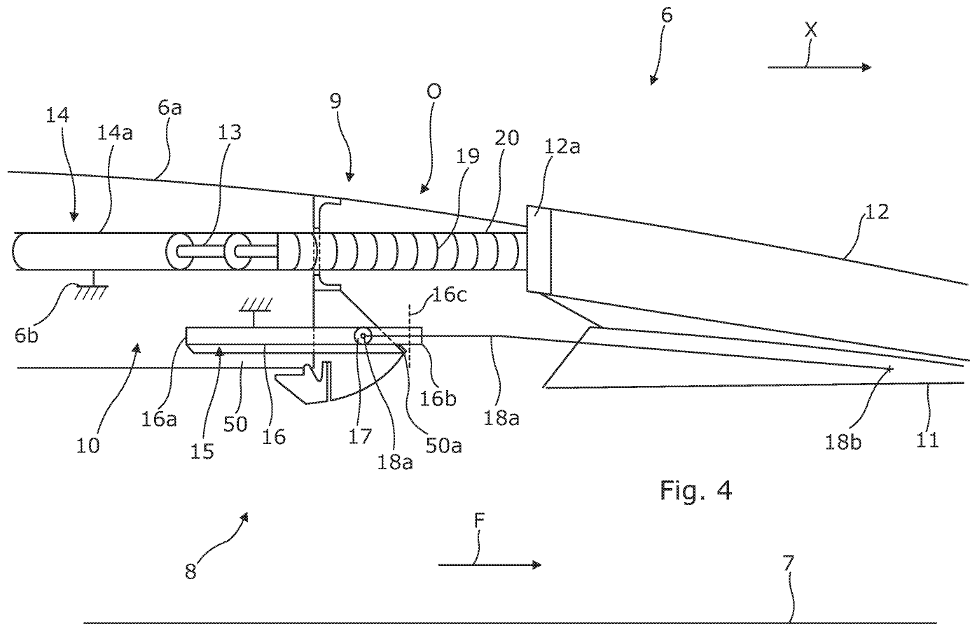

The operation of the thrust reverser 9 through the effect of the drive mechanism 10 is as follows, from the stowed position of the movable cowl 12 and the closed position of the blocking flap 11 (FIG. 3):
the actuator is activated such as to cause a translational movement of the slide bar 13 guided by the guide means 14 along the fixed structure in order to move the movable cowl/blocking flap/cascade assembly towards the rear of the nacelle 6. Thus, the movable cowl 12 moves from its stowed position towards the deployed position. Simultaneously with this movement (FIG. 4), the connecting rod 18 integral with the blocking flap 11 moves in translation in the rail 16, while being supported by the bearing surface 50, and pulls the roller 17 which rolls in the rail 16 and moves from the first end 16a towards the second end 16b of the rail; and
from the moment when the movable cowl 12 lies beyond the intermediate position, and in step with the connecting rod 18 no longer being supported by the bearing surface 50, the connecting rod 18 progressively turns about the center of the roller 17 such as to move the blocking flap 11 towards its open position with a view to closing off at least a part of the fan duct 8. The thrust reverser 9 is then “activated” (FIG. 5) and its efficiency is at maximum when the blocking flap 11 is in the open position.

The operation of the thrust reverser 9 through the effect of the drive mechanism 10 is as follows, from the deployed position of the movable cowl 12 and the open position of the blocking flap 11 (FIG. 5):
the actuator is activated such as to cause a translational movement of the slide bar 13 guided by the guide means 14 along the fixed structure in order to move the movable cowl/blocking flap/cascade assembly towards the front of the nacelle 6. Thus, the movable cowl 12 moves from its stowed position towards the deployed position and approaches the fixed cowl 6a in order to close the opening O;
as the movable cowl 12 moves towards the front (FIG. 4) and lies beyond the intermediate position, moving the blocking flap 11 forwards, the connecting rod 18 that has its end 18a restricted by its link to the roller 17 rolling in the rail 16 is progressively supported by the bearing surface 50, which gives rise to the progressive switch of the blocking flap 11 towards its closed position in such a manner as to free up the fan duct 8. The movement of the connecting rod 18 in the rail 16 pushes the roller 17 towards the first end 16a of the rail attained when the blocking flap 11 is in its closed position. In the closed position of the blocking flap 11, the thrust reverser 9 is “deactivated”.

Thus, the drive mechanism 10 according to the invention delays the switch from the closed position to the open position of the blocking flap 11 as compared with the switch from the stowed position to the deployed position of the movable cowl 12 since the blocking flap 11 does not begin to move towards its open position until the moment when the movable cowl 12 lies beyond its intermediate position. Such a drive mechanism 10 further offers the advantage of being entirely outside the fan duct 8 when the movable cowl 12 is in the stowed position and when the blocking flap 11 is in the closed position, in such a manner as not to generate parasitic drag.

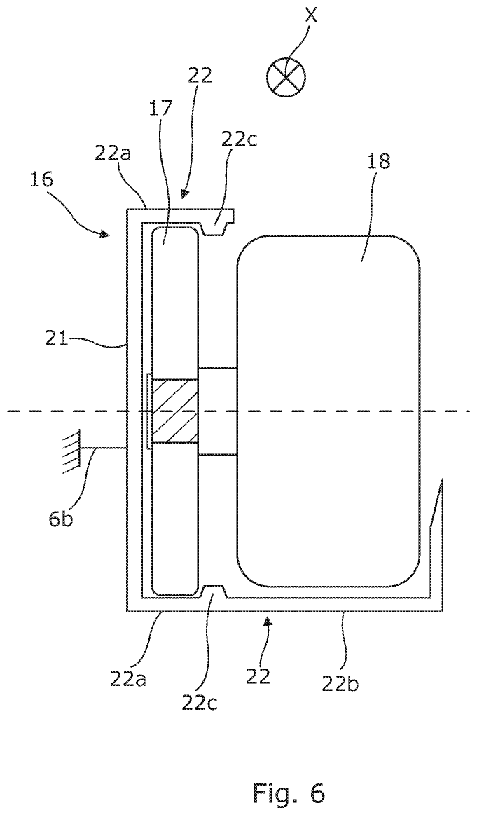

In an exemplary embodiment illustrated in FIG. 6, the rail 16, for example a folded sheet, conventionally has a U form, with a base 21 secured to the fixed structure and two mutually parallel wings 22 that extend outside the base 21 in an “extension” direction perpendicular to the longitudinal axis X.

Each wing 22 comprises, in the extension direction and from the base 21, a first portion 22a. A first portion 22a extends, in the translational direction, from the first end 16a to the second end 16b of the rail 16. The rail 16 comprises stop means (not shown), for example stops, arranged at each of its first 16a and of its second 16b ends in order to prevent any exit of the roller 17 outside of the rail 16.

The divergence between the first portions 22a of the two opposite wings 22 of a rail 16 is slightly greater than the diameter of the roller 17 such that the roller 17 is able to roll on the first portions 22a.

Each first portion 22a is extended, in the translational direction, by a rib 22c, for example with a cross section of trapezoidal form, extending in the translational direction, the peak of which is oriented towards the interior of the rail 16. The rib 22c makes it possible to maintain the roller 17 between the first portions 22a of the two opposite wings 22.

Furthermore, the wing 22 located closest to the fan duct 8 has, in the extension direction and from a first portion 22a, a substantially planar second portion 22b.

The second portion 22b extends from the first end 16a of the rail 16 as far as a pivot position 16c attained when the movable cowl 12 is in the intermediate position and forms the bearing surface 50 of the connecting rod 18. The rib 22c separating the first and the second portion 22a, 22b of a wing 22 makes it possible to prevent the connecting rod 18 becoming inserted between the first portions 22a of a wing 22.

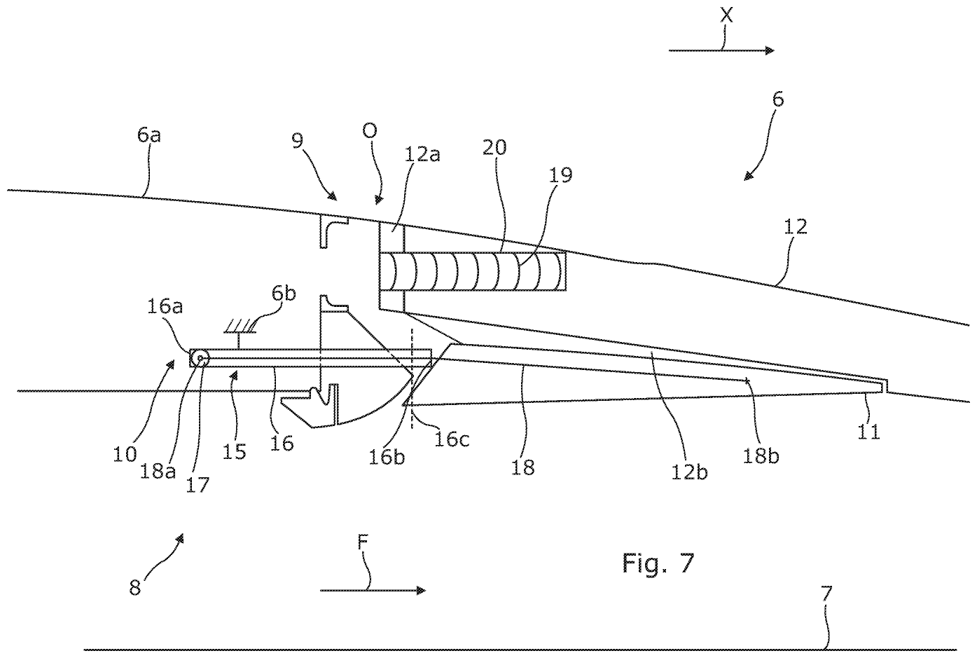

In another embodiment of the invention, and as shown in FIGS. 7 to 9, the turbojet 5 comprises cascades 19 arranged on a housing 20 integral with the chassis 6b and housed in the movable cowl 12 in the space delimited between the exterior surface and the interior surface of the movable cowl 12 when the latter is in the stowed position. In the deployed position of the movable cowl 12, the cascades, arranged across the opening O, orient, towards the front and the exterior of the nacelle, the flow of air F blocked by the blocking flap 11.

According to this embodiment, the drive mechanism 10 does not comprise a slide or means for guiding the slide. On the other hand, the thickness of the movable cowl 12 is increased such that it is possible to house the fixed cascades 19 therein.

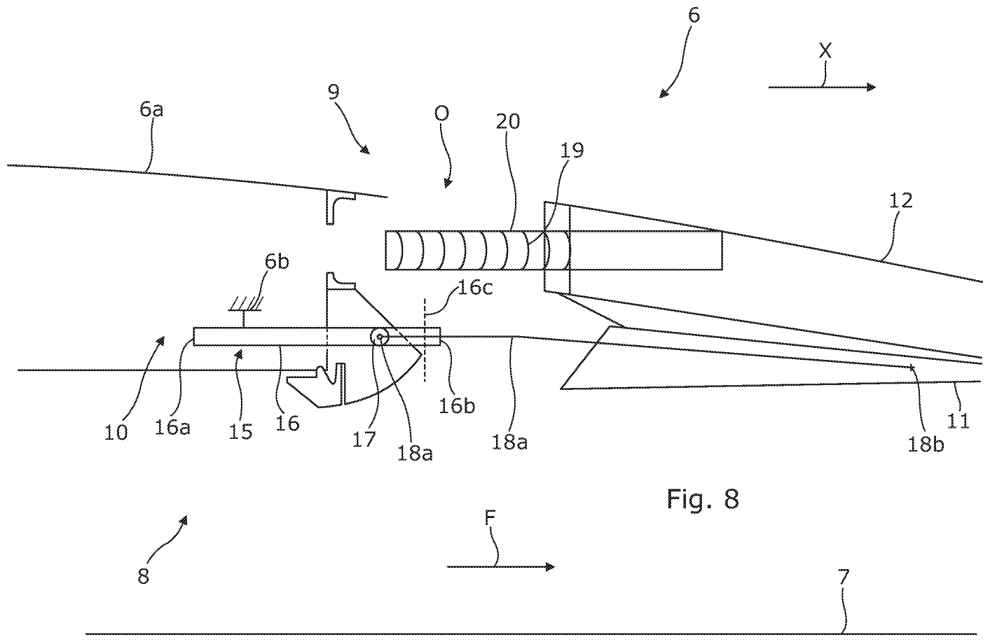

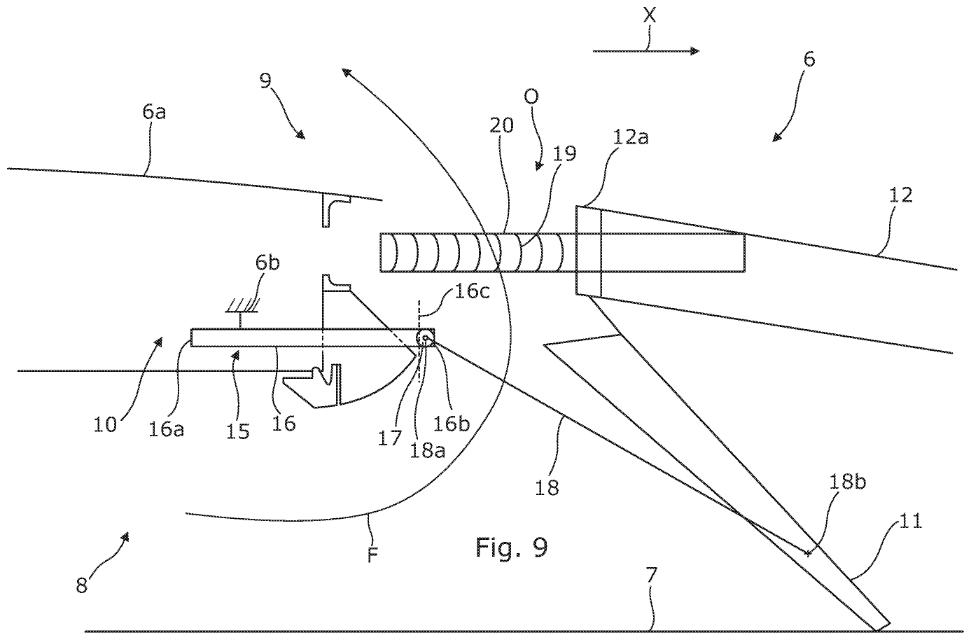

The operation of the thrust reverser 9 according to this embodiment through the effect of the drive mechanism 10 is as follows, from the stowed position of the movable cowl 12 and the closed position of the blocking flap 11 (FIG. 7):
the actuator is activated such as to cause a translational movement of the movable cowl/blocking flap assembly towards the rear of the nacelle 6. Thus, the movable cowl 12 moves from its stowed position towards the deployed position and the rearward movement of the movable cowl 12 frees up the cascades 19. Simultaneously with this movement (FIG. 8), the connecting rod 18 integral with the blocking flap 11 moves in translation in the rail 16 and pulls the roller 17 that rolls in the rail 16 and moves from the first end 16a towards the second end 16b of the rail; and
in step with the connecting rod 18 no longer being supported by the bearing surface 50, the latter progressively pivots about the center of the roller 17 such as to move the blocking flap 11 towards its open position in order to close off at least a part of the fan duct 8. When the blocking flap 11 attains its open position, the thrust reverser 9 is activated (FIG. 9).

The operation of the thrust reverser 9 through the effect of the drive mechanism 10 is as follows, from the deployed position of the movable cowl 12 and the open position of the blocking flap 11 (FIG. 9):
the actuator is activated such as to cause a movement of the movable cowl/blocking flap assembly towards the front of the nacelle 6. Thus, the movable cowl 12 moves from its stowed position towards the deployed position and approaches the fixed cowl 6a in order to close the opening O. The cascades 19 come to be housed in the thickness of the movable cowl 12 as the latter progresses towards its stowed position;
as the movable cowl 12 moves forwards (FIG. 8), moving the blocking flap 11 forwards, the connecting rod 18 that has its end 18a restricted by its link to the roller 17 rolling in the rail 16 is progressively supported by the bearing surface 50, which gives rise to the progressive switch of the blocking flap 11 towards its closed position in such a manner as to free up the fan duct 8. The movement of the connecting rod 18 pushes the roller 17 towards the first end 16a of the rail attained when the blocking flap 11 is in its closed position. When the blocking flap 11 attains its closed position, the thrust reverser 9 is deactivated (FIG. 7).

The invention has been described with reference to a single blocking flap, but it applies in the same way to each blocking flap or blocking-flap assembly when there is a plurality thereof.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A turbojet comprising:
an engine,
a nacelle with a longitudinal axis, and
a fan duct defined between the nacelle and the engine,
the nacelle having a chassis, a fixed cowl and a thrust reverser mounted on the chassis,
the thrust reverser comprising
a movable cowl mounted to move on the chassis in translation in a translational direction between a stowed position, in which the movable cowl is in contact with the fixed cowl, and a deployed position in which the movable cowl is remote from the fixed cowl,
at least one blocking flap that is moveable in rotation about an axis perpendicular to the longitudinal axis on the movable cowl between a closed position, in which the flap releases the fan duct, and an open position in which the flap blocks the fan duct at least in part, and
a drive mechanism for moving the movable cowl and the at least one blocking flap, the drive mechanism comprising:
a roller slide integral with the chassis and comprising a rail extending in the translational direction and a roller that can move in rotation in the rail over a total length of the rail defined between a first end of the rail attained when the blocking flap is in the closed position and the movable cowl is in the stowed position and a second end of the rail attained when the blocking flap is in the open position and the movable cowl is in the deployed position,
a connecting rod, of which a first end is mounted to move in rotation on the roller about an axis of rotation perpendicular to the longitudinal axis and of which a second end is mounted to move on the at least one blocking flap about an axis of rotation perpendicular to the longitudinal axis,
wherein the rail comprises a bearing surface extending in the translational direction and parallel to the longitudinal axis such as to support the connecting rod during a movement of the movable cowl from the stowed position to an intermediate position of the movable cowl, the intermediate position being between the stowed position and the deployed position of the movable cowl.

2. The turbojet according to claim 1, wherein the bearing surface extends from the first end of the rail as far as a pivot position attained when the movable cowl is in the intermediate position.

3. The turbojet according to claim 1, further comprising cascades.

4. The turbojet according to claim 3, wherein the cascades are arranged on a housing integral with the movable cowl, the drive mechanism comprising a slide bar integral with the housing and guide means configured such as to guide the slide bar in translation parallel to the direction and translation between two stop positions, one corresponding to the stowed position and the other to the deployed position of the movable cowl.

5. The turbojet according to claim 4, wherein the guide means comprise a groove integral with the chassis in and along which the slide bar slides.

6. The turbojet according to claim 3, wherein the cascades are arranged on a housing integral with the chassis of the nacelle.

7. The turbojet according to claim 1, wherein the bearing surface comprises a ramp extending in the translational direction and inclined relative to the longitudinal axis.
